(19) United States
(12) Patent Application Publication
(10) Pub. No.: US 2006/0053345 A1
(43) Pub. Date: Mar. 9, 2006

(54) Thin module system and method

(75) Inventor: Paul Goodwin, Austin, TX (US)

Correspondence Address: J. SCOTT DENKO, ANDREWS & KURTH LLP, 111 CONGRESS AVE., SUITE 1700, AUSTIN, TX, 78701, US

(73) Assignee: Staktek Group L.P.

(21) Appl. No.: 11/123,721

(22) Filed: May 6, 2005

Related U.S. Application Data
(63) Continuation-in-part of application No. 11/068,688, filed on Mar. 1, 2005.
(63) Continuation-in-part of application No. 11/005,992, filed on Dec. 7, 2004.
Application No. 11/068,688 is a continuation-in-part of application No. 11/007,551, filed on Dec. 8, 2004.
Application No. 11/068,688 is a continuation-in-part of application No. 10/934,027, filed on Sep. 3, 2004.

(51) Int. Cl. G06F 11/00

(52) U.S. Cl. 714/42

(57) ABSTRACT

A thin profile memory module is provided which, in a variety of modes, can supplant traditional DIMM constructions of a variety of types such as, for example, registered and fully-buffered. In preferred modes, a memory module is provided that can meet or exceed the interconnective and capacity requirements for SO-DIMMs yet can simultaneously meet or exceed the profile requirements for such devices. In preferred modes, a flex circuit is populated along each of its first and second major sides with a plurality of array type (CSP) devices. Insertion contacts are disposed in two sets on the first side of the flex circuit and disposed proximal to a long edge area of the flex circuit. A substrate with first and second major sides provides a form for the module. The flex circuit is wrapped about an edge of the substrate to place one set of the insertion contacts along the first side of the substrate and the other set of the insertion contacts along the second side of the substrate while the ICs populated along the second side of the flex circuitry are disposed between the flex circuit and the substrate.

### RELATED APPLICATIONS

This application is a continuation-in-part of U.S. patent application Ser. No. 11/068,688, filed Mar. 1, 2005 and a continuation-in-part of U.S. patent application Ser. No. 11/005,992, filed Dec. 7, 2004 both of which are hereby incorporated by reference herein. U.S. patent application Ser. No. 11/068,688 is a continuation-in-part of U.S. patent application Ser. No. 11/007,551, filed Dec. 8, 2004 which application is hereby incorporated by reference and is a continuation-in-part of U.S. patent application Ser. No. 10/934,027, filed Sep. 3, 2004 which application is hereby incorporated by reference herein.

### FIELD

The present invention relates to systems and methods for creating high density circuit modules.

### BACKGROUND

The well-known DIMM (dual in-line memory module) board has been used for years, in various forms, to provide memory expansion. A typical DIMM includes a conventional PCB (printed circuit board) with memory devices and supporting digital logic devices mounted on both sides. The DIMM is typically mounted in the host computer system by inserting a contact-bearing edge of the DIMM into a card edge connector. Systems that employ DIMMs provide, however, very limited profile space for such devices.

Memory modules are configured in a variety of ways, both dimensionally and electrically. A few examples include, registered DIMMs, fully buffered DIMMs (FB-DIMM), SO-DIMMS, PCI DIMMS, graphics modules that are similar to DIMMs and have on-board memory and graphics engines. Some of these variations can be combined. For example, a SO-DIMM can be configured in a fully buffered mode.

Smaller versions of DIMMs have been devised for use in applications where there is enhanced pressure for miniaturization. For example, notebook computer design highly values low weight and small size. These particularly acute constraints are translated to almost every component employed in such computers. In response to the physical constraints demanded by notebook design, the SO-DIMM was devised. In addition to smaller dimensions, a SO-DIMM (small outline dual in-line module) typically has fewer pins, sometimes known as insertion contacts or simply, contacts, than a traditional DIMM. Instead of 168 pins or contacts, a typical 32-bit SO-DIMM has 72 pins while a 64-bit transfer supporting SO-DIMM typically exhibits 144 pins or contacts. Smaller on board device form factors are also favored for use on SO-DIMMs.

Increased bus speeds have led to variations on DIMM electrical design. For example, the fully-buffered DIMM is meant to mitigate bus limitations at higher speeds. As bus speeds have increased, fewer devices per channel can be reliably addressed with a DIMM-based solution. For example, 288 ICs or devices per channel may be addressed using the SDRAM-100 bus protocol with an unbuffered DIMM. Using the DDR-200 bus protocol, approximately 144 devices may be address per channel. With the DDR2-400 bus protocol, only 72 devices per channel may be addressed. This constraint has led to the development of the fully-buffered DIMM (FB-DIMM) with buffered C/A and data in which 288 devices per channel may be addressed. With the FB-DIMM, not only has capacity increased, module pin count has declined.

The FB-DIMM circuit solution is expected to offer practical motherboard memory capacities of up to about 192 gigabytes with six channels and eight DIMMs per channel and two ranks per DIMM using one gigabyte DRAMs. This solution should also be adaptable to next generation technologies and should exhibit significant downward compatibility.

This improvement has, however, come with some cost and will eventually be self-limiting. The basic principle of systems that employ FB-DIMM relies upon a point-to-point or serial addressing scheme rather than the parallel multi-drop interface that dictates non-buffered DIMM addressing. That is, one DIMM is in point-to-point relationship with the memory controller and each DIMM is in point-to-point relationship with adjacent DIMMs. Consequently, as bus speeds increase, the number of DIMMs on a bus will decline as the discontinuities caused by the chain of point to point connections from the controller to the “last” DIMM become magnified in effect as speeds increase. Consequently, methods to increase the capacity of a single DIMM find value in contemporary memory and computing systems.

Methods and systems that provide minimal profiles and preferably improve thermal management for DIMMs while being adaptable to a variety of DIMM types such as, for example, registered or fully-buffered modules, are welcome additions to the repertoire of system designers.

### SUMMARY

A thin profile module is provided which, in a variety of modes, can supplant traditional module constructions of a variety of types such as, for example, registered and fully-buffered DIMMs. In preferred modes, a memory module is provided that can meet or exceed the interconnective and capacity requirements for SO-DIMMs yet can simultaneously meet or exceed the profile requirements for such devices.

In some preferred modes, a flex circuit is populated along each of its first and second major sides with ICs which are preferably, array type (CSP) devices. Insertion contacts are disposed in two sets on the first side of the flex circuit and disposed proximal to a long edge area of the flex circuit. A substrate with first and second major sides provides a form for the module. The flex circuit is wrapped about an edge of the substrate to place one set of the insertion contacts along the first side of the substrate and the other set of the insertion contacts along the second side of the substrate while the ICs populated along the second side of the flex circuitry are disposed between the flex circuit and the substrate.

For modules that have at least one IC device of a second type having a taller profile than the nearby ICs of the first type resident on the second side of the flex circuit, a dimpling or contouring or shaping of the substrate provides a cavity for at least a part of the taller profile device to allow the upper surface of at least one of the ICs on the second side of the flex circuit to mount against the substrate thus minimizing the module profile when such taller profile ICs such as buffers, for example, are employed.

### BRIEF DESCRIPTION OF THE DRAWINGS

FIGS. 1A and 1B are depictions of first and second sides of a preferred embodiment of a module devised in accordance with the present invention.

FIG. 2 depicts a first side of a flex circuit devised in accordance with a preferred embodiment of the present invention.

FIG. 3 depicts the second side of the exemplar populated flex circuit of FIG. 2.

FIG. 4 depicts another flex circuit that may be employed in embodiments of the present invention.

FIG. 5 is a cross-sectional depiction through a module devised in accordance with a preferred embodiment.

FIG. 6 is an enlarged view of the area of the module depicted in FIG. 5 and marked “A”.

FIG. 7 depicts another cross-sectional view of a module devised in accordance with the present invention.

FIG. 8 depicts another preferred embodiment of the present invention.

FIG. 9 depicts an exploded view of a flex circuit employed in a preferred embodiment of the present invention.

### DETAILED DESCRIPTION OF PREFERRED EMBODIMENTS

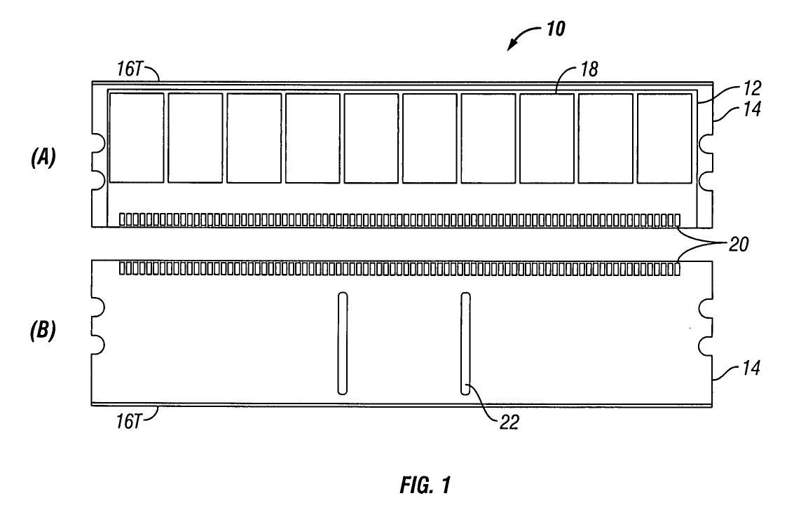

FIG. 1A depicts a first side of a preferred embodiment of a module 10 devised in accordance with the present invention. Depicted are flex circuit 12 populated with ICs 18 and substrate 14. ICs 18 have upper surfaces 18_{T} and as shown in a later Fig., lower surfaces 18_{B}. Contacts 20 (module or insertion contacts) are shown on each side of module 10. Integral strain reliefs 22 are shown in substrate 14 as depicted in FIG. 1B. Optional extension 16T of substrate 14 is shown but depicted in more detail in later Figs.

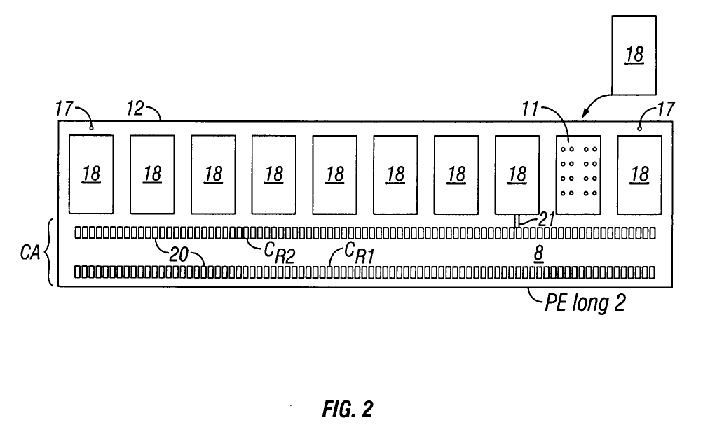

FIG. 2 depicts a first side 8 of flex circuit 12 (“flex”, “flex circuitry”, “flexible circuit”) used in constructing a module according to an embodiment of the present invention. Flex circuit 12 is preferably made from one or more conductive layers supported by one or more flexible substrate layers. The general construction principles of flex circuitry are known in the art but some useful features are depicted in later Figs. The entirety of the flex circuit 12 may be flexible or, as those of skill in the art will recognize, the flexible circuit structure 12 may be made flexible in certain areas to allow conformability to required shapes or bends, and rigid in other areas to provide rigid and planar mounting surfaces.

ICs 18 on flexible circuit 12 are, in this embodiment, preferably array or chip-scale packaged memory devices of small scale. For purposes of this disclosure, the term chip-scale or “CSP” shall refer to integrated circuitry of any function with an array package providing connection to one or more die through contacts (often embodied as “bumps” or “balls” for example) distributed across a major surface of the package or die. CSP does not refer to leaded devices that provide connection to an integrated circuit within the package through leads emergent from at least one side of the periphery of the package such as, for example, a TSOP.

Embodiments of the present invention may be employed with leaded or CSP devices or other devices in both packaged and unpackaged forms but where the term CSP is used, the above definition for CSP should be adopted. Consequently, although CSP excludes leaded devices, references to CSP are to be broadly construed to include the large variety of array devices (and not to be limited to memory only) and whether die-sized or other size such as BGA and micro BGA as well as flip-chip. Consequently, some embodiments of the present invention may be implemented to articulate modules that have functions in addition or other than memory such as for example, graphics modules. As those of skill will understand after appreciating this disclosure, some embodiments of the present invention may be devised to employ stacks of ICs each disposed where an IC 18 is indicated in the exemplar Figs.

Multiple integrated circuit die may be included in a package depicted as a single IC 18. While in this embodiment memory ICs are used to provide a memory expansion board or module, various embodiments may include a variety of integrated circuits and other components. Such variety may include microprocessors, FPGA's, RF transceiver circuitry, digital logic, as a list of non-limiting examples, or other circuits or systems which may benefit from a high-density circuit board or module capability.

A contact area region CA of flex circuit 12 is shown and exhibits in this preferred embodiment, first and second rows CR1 and CR2, respectively, of contacts 20 shown along first side 8 of flex circuit 12. Contacts 20 are preferably devised as insertion contacts appropriate for use with insertion or edge sockets typically found employed for placement of DIMMs on mother and other circuit boards. Contacts 20 may be oriented other than in rows but it will be appreciated that DIMM applications employ contact sets arranged in rows. When flex circuit 12 is disposed about substrate 14 as later depicted, side 8 depicted in FIG. 2 is presented at the outside of module 10. The opposing side 9 of flex circuit 12 is on the inside in several depicted configurations of module 10 and thus in such embodiments, side 9 is closer to the substrate 14 about which flex circuit 12 is disposed than is side 8.

The depiction of FIG. 2 shows side 9 of flex circuit 12 as having first field F1 for mounting a plurality of ICs and preferably CSPs. Each of fields F1 on sides 8 and 9 respectively have at least one mounting contact array for CSPs such as the one depicted by reference 11. Contact arrays such as array 11 are disposed beneath ICs 18 and IC 19. IC 19 depicted between ICs 18 may be a buffer or controller, for example, and in a preferred embodiment it may be the well known advanced memory buffer or “AMB” although it can be a circuit of a variety of types. Consequently, the module as depicted is populated with ICs of a first type (e.g., memory 18) and at least one IC of a second type such as IC 19. In preferred modes, side 9 of flex circuit 12 will be populated with a plurality of CSPs of a first type and at least one CSP of a second type. An exemplar contact array 11 is shown as is exemplar IC 18 to be mounted at contact array 11 as depicted. The contact arrays 11 that correspond to an IC plurality may be considered a contact array set.

Side 9 of flex circuit 12 is shown populated with a plurality of CSPs (IC_{R1}) and it should be recognized that first side 8 is also populated with a plurality of CSPs. Those of skill will recognize that the identified pluralities of CSPs are, when disposed in the configurations depicted, typically described as “ranks”. Other embodiments may have other numbers of ranks and combinations of plural CSPs connected to create the module of the present invention.

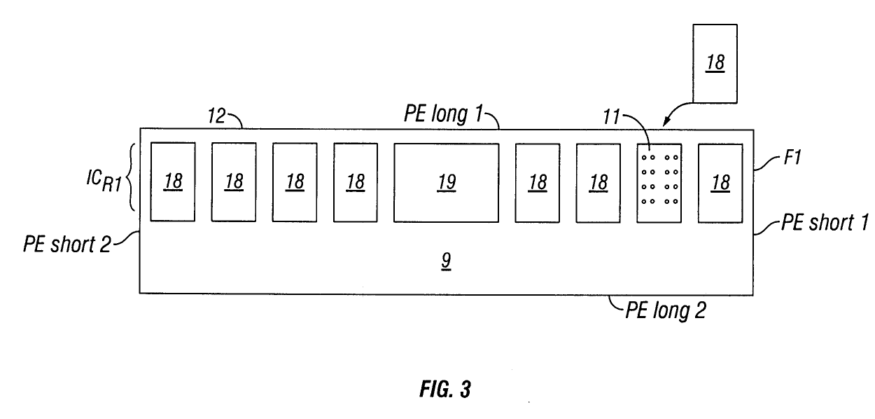

FIG. 3 shows side 9 of flex circuit 12 depicting the other side of the flex circuit shown in FIG. 2. Side 9 of flex circuit 12 is shown as being populated with multiple ICs 18 and IC 19 which as stated may be in a preferred embodiment a buffer for some or all of the signals communicated to and from the CSPs 18. IC 19 may also represent a variety of other circuits such as graphics engines for example.

Various discrete components such as termination resistors, bypass capacitors, and bias resistors, in addition to circuits such as IC 19 shown on side 9 of flex circuit 12, may be mounted on either or both of sides 8 and 9 of flex 12. Such discrete components are not shown to simplify the drawing.

As those of skill will recognize, mounting taller profile devices on side 9 such as IC 19 can prevent planar mounting of the upper surfaces 18_{T} of ICs 18 along side 9 to the first side of substrate 14. In preferred modes, substrate 14 accommodates such taller devices with contouring or dimpling or extrusion or a variety of other shaping methods and techniques known in the art to create a cavity into which, at least in part, taller profile devices such as IC 19 (CSP 19) may reside to realize a thinner profile for module 10.

Flex circuit 12 may also depicted with reference to its perimeter edges, two of which are typically long (PE_{long1} and PE_{long2}) and two of which are typically shorter (PEₛₕₒᵣₜ₁ and PEₛₕₒᵣₜ₂). Other embodiments may employ flex circuits 12 that are not rectangular in shape and may be square in which case the perimeter edges would be of equal size or other convenient shape to adapt to manufacturing particulars. Other embodiments may also have fewer or greater numbers of ranks or pluralities of ICs in each field or on a side of a flex greater numbers of circuits.

FIG. 2 depicts an exemplar conductive trace 21 connecting row C_{R1} of module contacts 20 to ICs 18. Those of skill will understand that there are many such traces in a typical embodiment. Traces 21 may also connect to vias that may transit to other conductive layers of flex 12 in certain embodiments having more than one conductive layer. In a preferred embodiment, vias connect ICs 18 on side 9 of flex 12 to module contacts 20. An example via is shown as reference 23. Traces 21 may make other connections between the ICs on either side of flex 12 and may traverse the rows of module contacts 20 to interconnect ICs. Together the various traces and vias make interconnections needed to convey data and control signals amongst the various ICs and buffer circuit(s). Those of skill will understand that the present invention may be implemented with only a single row of module contacts 20 and may, in other embodiments, be implemented as a module bearing ICs on only one side of flex circuit 12.

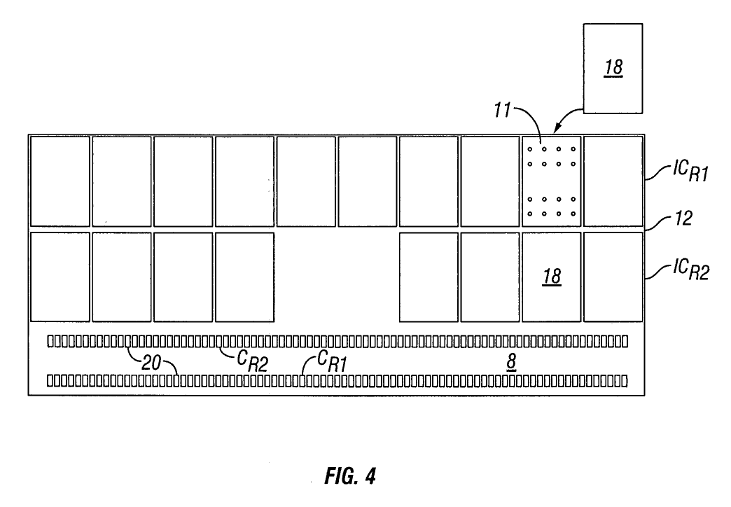

FIG. 4 depicts a side 8 of another embodiment of a flex circuit 12 that may be employed in a preferred embodiment of the present invention. The depiction of FIG. 4 illustrates the use of smaller ICs 18 and, as those of skill will appreciate after considering this disclosure, one or more buffer circuits 19 can be mounted on side 9 of flex circuit 12 to provide a dual instantiation FB-DIMM circuitry on a single module 10 of low profile where the buffers 19 may reside in deformations, contouring or dimplings of substrate 14.

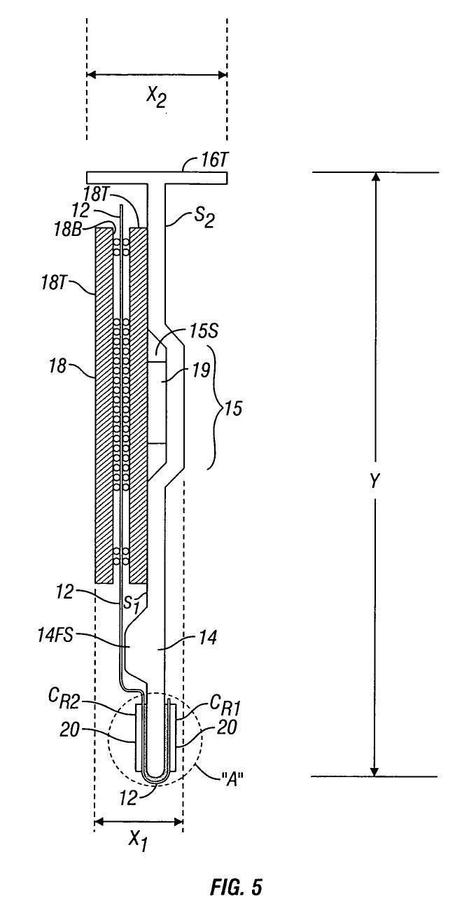

FIG. 5 is a cross section view of a module 10 devised in accordance with a preferred embodiment of the present invention. The cross-sectional view of FIG. 5 is taken through IC 19 which is shown with its taller profile than the nearby ICs 18. As shown in FIG. 5, substrate 14 exhibits a contour or deformation 15 (or extruded bend, for example) that leaves a cavity 15S. Thus substrate 14 is contoured, deformed or bent or shaped or extruded, for example, to cooperate with the taller profile of IC 19 to allow a module 10 of profile X1 to be assembled with a minimized profile. In one preferred embodiment, profile X1 may be about 4.5 mm (±0.3 mm) although it must be made clear that such a profile measurement is merely exemplary. Although such a profile dimension is typically considered beneficial in DIMM applications, modules 10 in accordance with the invention may be devised in a wide variety of dimensions including and other than 4.5 mm. Some preferred embodiments of module 10 have been designed to have a height Y of about 30.35 mm (±0.3 mm) but that too is merely an exemplary dimension and modules 10 will be configurable with a wide variety of heights Y including and other than 30.35 mm.

Upper surface 18_{T} of at least some of ICs 18 are employed in the preferred embodiment of FIG. 5 to attach the IC-populated flex circuit 12 to substrate 14. Preferably, thermal glues or adhesives are used for such attachment. Extension 16T of substrate 16 (shown in this embodiment as a “T” shape) can function to assist in thermal cooling of module 10. Extension 16T can also take many other shapes or be repeated iterations of shapes such as the depicted T.

Preferably, materials for substrate 14 are metallic to assist in thermal management of module 10. In preferred modes, the plurality of ICs (preferably CSPs) that populate side 9 of flex circuit 12 are between flex circuit 12 and substrate 14. When at least one and preferably more of the upper surfaces 18_{T} of those CSPs are adhered to substrate 14, the preferred metallic material of substrate 14 encourages extraction of thermal energy from the CSPs that operate in conjunction in the module. Consequently, substrate 14 in preferred embodiments is preferably made of a metallic material such as aluminum or copper, as non-limiting examples, or where thermal management is less of an issue, materials such as FR4 (flame retardant type 4) epoxy laminate, PTFE (poly-tetra-fluoro-ethylene) or even plastic may be employed. In another embodiment, advantageous features from multiple technologies may be combined with use of FR4 having a layer of copper on both sides to provide a substrate 14 devised from familiar materials which may provide heat conduction or a ground plane.

While contacts 20 are shown protruding from the surface of flex circuit 12, other embodiments may have flush contacts or contacts below the surface level of flex 12. Substrate 14 supports contacts 20 from behind flex circuit 12 in a manner devised to provide the mechanical form required for insertion into a socket. In other embodiments, the thickness or shape of substrate 14 in the vicinity of perimeter edge 16A may vary.

Substrate or support structure 14 has a first perimeter edge identified as 16A and a second limit depicted in the depiction of FIG. 5 as extension 16T although those of skill will recognize that extension 16T can be devised in a variety of shapes or may be merely a conformal second edge with no special extension or shaping features. In the depicted embodiment, extension 16T has a dimension X2 of approximately or about 7 mm to take fully advantage of some application area requirements for DIMMs with the enhanced thermal management feature of extension 16T, but those of skill will recognize that such dimensional suggestions or preferences are merely exemplary and embodiments of module 10 may be devised that exhibit dimensions for extension 16T that vary from or include 7 mm while other embodiments may not exhibit any extension from substrate 14. For example, extension 16T may be reduced in size so that module 10 exhibits dimensions of X1 as well as X2 that are approximately or about 4.5 mm (±0.3 mm), which is, as those of skill will recognize, a low profile for a FB-DIMM type module.

Substrate or support structure 14 typically has first and second lateral sides S₁ and S₂. As shown, at least a part of region CA of flex circuitry 12 is wrapped about perimeter edge 16A of substrate 14 to dispose contact row CR1 closer to the S2 side of substrate 14 than is placed contact row CR2. Typically, contact row CR1 may be said to be on side S2 of substrate 14. Practical use of adhesives and glues should not lead to interpretations that conclude that contract row CR1 is not on side S2 of substrate 14 just because the contacts of the contact set or row is distanced from substrate 14 by adhesive or the body of the flex circuit, for example. However, to avoid any such misinterpretation it is pointed out that contacts CR1 are closer to side S2 of substrate 14 than are the contacts of contact row CR2 just as the contacts of contact row CR2 are closer to side S1 of substrate 14 than are the contacts of contact row CR1.

Substrate flex support 14_{FS} is shown providing support for flex circuit 12. Those of skill will recognize that feature 14_{FS} is optional but provides support for flex circuitry along substrate 14. Other embodiments may leave the area occupied by 14_{FS} empty or fill it with conformal fillers or pastes.

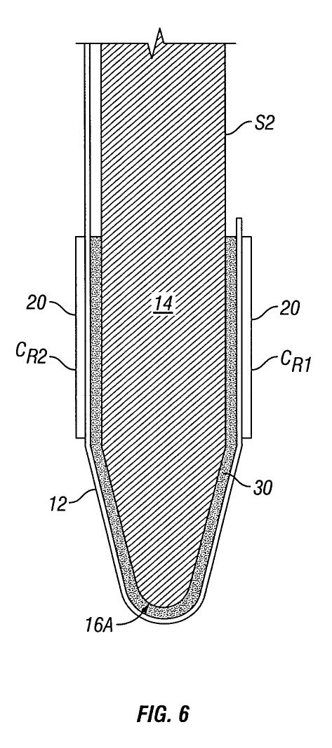

An enlarged detail is shown in FIG. 6 as part of flex circuit 12 is disposed about edge 16A of substrate 14. Edge 16A of substrate 14 is shaped like a male side edge of an edge card connector. While a particular oval-like configuration is shown, edge 16A may take on other shapes devised to mate with various connectors or sockets. The form and function of various edge card connectors are well know in the art. In many preferred embodiments, flex 12 is wrapped around edge 16A of substrate 14 and may be laminated or adhesively connected to substrate 14 with adhesive 30. The depicted adhesive 30 and flex 12 may vary in thickness and are not drawn to scale to simplify the drawing. The depicted substrate 14 has a thickness such that when assembled with the flex 12 and adhesive 30, the thickness measured between module contacts 20 falls in the range specified for the mating connector.

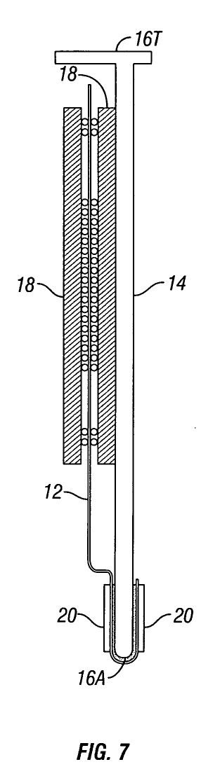

FIG. 7 depicts a cross-sectional view of a preferred embodiment of a module 10 devised in accordance with the present invention. The depicted view can be characterized as illustrating a cross-section of a module 10 that does not include a taller profile IC 19 or a cross-section of a module 10 taken through ICs 18 of a module 10 that may include a taller IC 19 at a location not disclosed in FIG. 7.

Module 10 includes a flex circuit 12 populated on sides 8 and 9 with ICs 18 with the upper surfaces 18_{T} of at least one of the plurality of ICs 18 proximal to side S1 of substrate 14 being employed to affix the populated flex circuit to substrate 14. Substrate 14 does not include 14_{FS} in the depicted embodiment. The module 10 depicted in FIG. 7 employs extension 16T which as depicted is just one of a multiplicity of configurations that may be employed as an extension to substrate 14 where such extension is desired.

With the construction of an embodiment such as that shown in FIGS. 5 and 7, and particularly when substrate 14 is metallic, thermal energy will be urged to move between the respective ICs 18 and substrate 14. Thus, module 10 may exhibit improved thermal characteristics with substrate 14 becoming a thermal mass sharing and assisting in dissipation of the thermal load. Flex circuit 12 may be particularly devised to operate as a heat spreader or sink adding to the thermal conduction out of ICs 18 and 19.

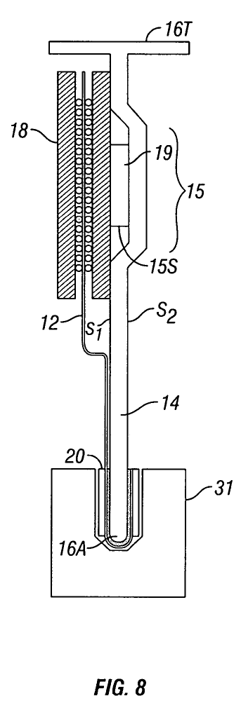

FIG. 8 depicts a cross-sectional construction of a preferred module 10 inserted into card edge connector 31. As those of skill will recognize, edge connector 31 may be a part of a variety of other devices such as general purpose computers or notebooks. Substrate 14 is shown as having a uniform thickness and contour or deformation or dimple 15 with space 15S being accommodative of IC 19. However, substrate 14 need not be of uniform thickness as shown in a variety of the US patent applications incorporated by reference herein all of which are owned by Staktek Group L.P. the assignee of the present application.

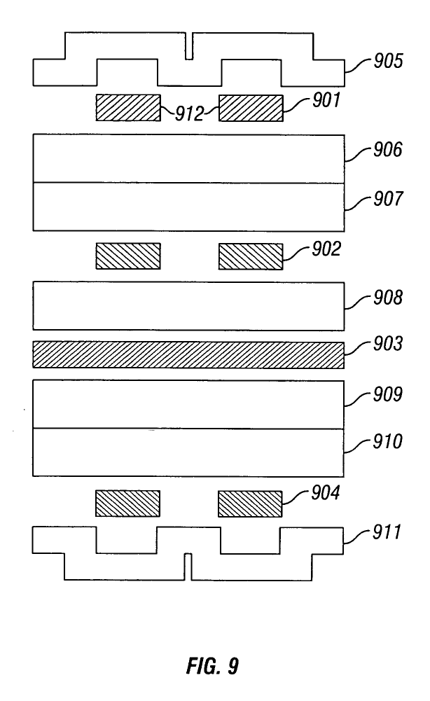

FIG. 9 depicts an exploded cross-sectional view of a flex circuit 12 that may be employed in some preferred embodiments of the present invention. The depicted flex circuit 12 has four conductive layers 901-904 and seven insulative layers 905-911. The numbers of layers described are merely those of one preferred embodiment and other numbers and layer arrangements may be employed.

Top conductive layer 901 and the other conductive layers are preferably made of a conductive metal such as, for example, copper or alloy 110. In this arrangement, conductive layers 901, 902, and 904 express signal traces 912 that make various connections on flex circuit 12. These layers may also express conductive planes for ground, power, and reference voltages. For example, top conductive layer 901 may also be provided with a flood, or plane to provide the VDD to ICs mounted to flex circuit 12.

In this embodiment, inner conductive layer 902 expresses traces connecting to and among the various devices mounted along the sides of flex circuit 12. The function of any of the depicted conductive layers may, of course, be interchanged with others of the conductive layers. Inner conductive layer 903 expresses a ground plane, which may be split to provide VDD return for pre-register address signals in designs that employ such registers. Inner conductive layer 903 may further express other planes and traces. In this embodiment, floods or planes at bottom conductive layer 904 provides VREF and ground in addition to the depicted traces.

Insulative layers 905 and 911 are, in this embodiment, dielectric solder mask layers which may be deposited on the adjacent conductive layers. Insulative layers 907 and 909 are made of adhesive dielectric. Other embodiments may not have such adhesive dielectric layers. Insulative layers 906 908, and 910 are preferably flexible dielectric substrate materials made of polyimide. Any other suitable flexible circuit substrate material may be used.

One advantageous methodology for efficiently assembling a circuit module 10 such as described and depicted herein is as follows. In a preferred method of assembling a preferred module assembly 10, flex circuit 12 is placed flat and both sides populated according to circuit board assembly techniques known in the art. Flex circuit 12 is then folded about end 16A of substrate 14. Flex 12 may be laminated or otherwise attached to substrate 14 through, for example, upper surfaces 18_{T} of ICs 18. The present invention may be employed to advantage in a variety of applications and environment such as, for example, in computers such as servers and notebook computers by being placed in motherboard expansion slots to provide enhanced memory capacity while utilizing fewer sockets or where minimal profiles are of value.

Although the present invention has been described in detail, it will be apparent to those skilled in the art that many embodiments taking a variety of specific forms and reflecting changes, substitutions and alterations can be made without departing from the spirit and scope of the invention. Just as one example, the principles of the present invention may be employed where only one IC 18 is resident on a side of a flex circuit 12 or where multiple ranks or pluralities of ICS are resident on a side of flex circuit 12, or where multiple ICs 18 are stacked and therefore disposed one atop the other to give a single module 10 materially greater capacity.

Therefore, the described embodiments illustrate but do not restrict the scope of the claims.

1. A circuit module comprising:
a flex circuit having a first side and a second side and first and second sets of plural contacts along the first side adapted for connection to a circuit board socket;
a first plurality of CSPs along the first side of the flex circuit and a second plurality of CSPs along the second side of the flex circuit;
a substrate having first and second lateral sides and an edge about which a part of the flex circuit is disposed to place the first set of plural contacts closer to the second side of the substrate than are disposed the second set of plural contacts and the second set of plural contacts closer to the first side of the substrate than are disposed the second set of plural contacts while the first and second pluralities of CSPs are each disposed closer to the first side of the substrate than the second side of the substrate.

2. The circuit module of claim 1 in which the second plurality of CSPs are disposed between the substrate and the flex circuit.

3. The circuit module of claim 2 in which the second plurality of CSPs includes CSPs of a first type and at least one CSP of a second type.

4. The circuit module of claim 3 in which the CSPs of the first type are memory devices.

5. The circuit module of claim 4 in which the at least one CSP of the second type is a buffer circuit.

6. The circuit module of claim 5 in which the buffer circuit is an AMB.

7. The circuit module of claim 1 in which the second plurality of CSPs includes CSPs of a first type that each have an upper surface and at least one CSP of a second type.

8. The circuit module of claim 7 in which the at least one CSP of the second type has a taller profile than the CSPs of the first type and the substrate is dimpled to allow at least one of the CSPs of the first type to be attached to the first side of the substrate by adhesion of the upper surface of the at least one of the CSPs of the first type to the first side of the substrate.

9. The circuit module of claim 7 in which the at least one CSP of the second type has a taller profile than the CSPs of the first type and the substrate is shaped to create a cavity into which at least in part, the at least one CSP of the second type resides.

10. The circuit module of claim 2 inserted into a card edge connector.

11. The circuit module of claim 2 in which the module has an X1 profile of about 4.5 mm.

12. The circuit module of claim 2 in which the module has a Y profile of about 33.5 mm.

12. The circuit module of claim 2 in which the substrate of the module is comprised of a metallic material.

13. The circuit module of claim 12 in which at least some of the CSPs of the first plurality of CSPs are stacks.

14. The circuit module of claim 12 in which the substrate exhibits an extension.

15. The circuit module of claim 9 in which the substrate is comprised of a metallic material.

16. A circuit module comprising:
a flex circuit having a first major side populated with a plurality of CSPs and a second major side populated with a plurality of CSPs, the first major side having first and second sets of plural insertion contacts;
a substrate having first and second lateral sides and an edge about which is disposed a part of the flex circuit to place the first set of plural insertion contacts along the second lateral side of the metallic material substrate and the second set of plural insertion contacts along the first lateral side of the metallic material substrate and the plurality of CSPs that populate the second major side of the flex circuit being disposed between the metallic material substrate and the flex circuit.

17. The circuit module of claim 16 in which the substrate is comprised of a metallic material and includes an extension from which thermal energy is dissipated.

18. The circuit module of claim 16 in which the plurality of CSPs that populate the second major side of the flex circuit include CSPs of a first type and at least one CSP of a second type.

19. The circuit module of claim 18 in which the CSPs of the first type are memory devices and the at least one CSP of the second type is a buffer circuit.

20. The circuit module of claim 18 in which the at least one CSP of the second type has a taller profile than do the CSPs of the first type.

21. The circuit module of claim 20 in which the substrate is shaped to create a cavity in which, at least in part, the at least one CSP of the second type resides.

22. The circuit module of claim 21 in which the substrate is comprised of a metallic material and has an extension.

23. The of claim 18 having a profile of X1 of about 4.5 mm.

24. The of claim 21 having a profile of X1 of about 4.5 mm.

25. The of claim 20 in which the at least one CSP of the second type is a buffer circuit.

26. The of claim 25 in which the buffer circuit is an AMB.

27. A circuit module to encourage the extraction of thermal energy from a CSP that operates in conjunction with at least one other CSP in the circuit module, the circuit module comprising:
a flex circuit having a set of insertion contacts and a first side populated with a plurality of CSPs and a second side populated with a plurality of CSPs, each of the CSPs having an upper surface;
a metallic material substrate having first and second lateral sides and an extension and an edge about which the flex circuit is disposed, the CSPs that populate the second side of the flex circuit being disposed between the first lateral side of the metallic material substrate and the flex circuit with at least some of the upper surfaces of said CSPs being thermally connected to the first lateral side of the metallic material substrate while the insertion contacts are disposed proximal to the edge of the metallic material substrate to allow insertion of the circuit module into an edge connector.

28. The circuit module of claim 27 inserted into an edge connector.
